(19) United States
(12) Patent Application Publication
(10) Pub. No.: US 2025/0385622 A1
(43) Pub. Date: Dec. 18, 2025

(54) VIBRATION TYPE MOTOR, DRIVE APPARATUS, AND VIDEO DISPLAY APPARATUS

(71) Applicant: CANON KABUSHIKI KAISHA, Tokyo (JP)

(72) Inventor: KAZUHARU OSAWA, Tokyo (JP)

(21) Appl. No.: 19/232,571

(22) Filed: Jun. 9, 2025

(30) Foreign Application Priority Data
Jun. 12, 2024 (JP) 2024-095444

(51) Int. Cl. H02N 2/04; G02B 7/04; G02B 27/01; H02N 2/00

(52) U.S. Cl. CPC H02N 2/04; G02B 7/04; G02B 27/0176; H02N 2/001; H02N 2/006

(57) ABSTRACT

A vibration type motor includes a vibrator having projections that vibrate by voltage application, a contact member in contact with the projections, a holding mechanism holding the vibrator, and a pressure mechanism pressing the vibrator toward the contact member. The motor includes a fixed unit and a movable unit movable relative to the fixed unit by vibrating the vibrator. The holding mechanism has a first fixed member into which a fastening member fixing the motor and a base member of an apparatus with driven members is inserted. A fixed guide member in the fixed unit guiding movement of the movable unit relative to the fixed unit has a second fixed member into which the fastening member is inserted. The first and the second fixed members are adjacently disposed in the direction the fastening member is inserted into the first fixed member.

### BACKGROUND OF THE INVENTION

### Field of the Invention

The present disclosure relates to a vibration type motor.

### Description of the Related Art

Japanese Patent Application Laid-Open No. 2018-98958 discusses a method for a vibration type motor. The method includes vibrating a vibrator having projections to cause an elliptic motion at the tips of the projections to generate a driving force by the elliptic motion of the projections.

Advantages of a vibration type motor of this type include linear drive as well as smooth and silent drive.

There has been demanded a diopter adjustment function in a video display apparatus such as a Head Mount Display (hereinafter referred to as an HMD) mounted on the user's head. The diopter adjustment function enables improving the visibility of close objects and reducing dizziness, by focusing a video image without using glasses and adjusting the focal distance of the video image according to the gaze point of the user.

Japanese Patent Application Laid-Open No. 2023-033070 discusses a diopter adjustment method for linearly driving a display unit or display optical system in the optical axis direction by using a vibration type motor. This method requires a small number of sliding members and involves a small load in moving driven members, thus achieving smooth and silent diopter adjustment.

Video display apparatuses such as HMDs used by being mounted on the user's head need to be downsized in order to reduce the load on the user and therefore need to downsize the vibration type motor to be mounted. However, like the vibration type motor discussed in Japanese Patent Application Laid-Open No. 2018-98958, a vibration type motor uses a plurality of combined members and incorporates a vibrator that vibrates at a high frequency. Therefore, each member is fastened by a fastening member such as a screw to prevent unnecessary vibration and sound from being generated by the vibration of the vibrator. Accordingly, this increases the numbers of screws and structural parts around screws in the vibration type motor, possibly increasing the sizes of the vibration type motor and the video display apparatus.

### SUMMARY OF THE INVENTION

The present disclosure has been made in consideration of the above situation, and provides a vibration type motor that is prevented from increasing in size.

According to an aspect of the present disclosure, a vibration type motor includes a vibrator having projections, the vibrator being configured to vibrate by a voltage application, a contact member configured to come into contact with the projections of the vibrator, a holding mechanism configured to hold the vibrator, a pressure mechanism configured to press the vibrator toward the contact member, a fixed unit, and a movable unit movable relative to the fixed unit by vibrating the vibrator, wherein the holding mechanism includes a first fixed member into which a fastening member, configured to fix the vibration type motor and a base member of an apparatus having driven members, is inserted, wherein the fixed unit includes a fixed guide member configured to guide a movement of the movable unit relative to the fixed unit, the fixed guide member including a second fixed member into which the fastening member is inserted, and wherein the first and the second fixed members are adjacently disposed in a direction in which the fastening member is inserted into the first fixed member.

Further features of the present disclosure will become apparent from the following description of exemplary embodiments with reference to the attached drawings.

### BRIEF DESCRIPTION OF THE DRAWINGS

FIGS. 1A to 1C illustrate outer appearances of a vibration type motor according to a first exemplary embodiment of the present disclosure.

FIGS. 2A and 2B are fragmentary perspective views illustrating the vibration type motor according to the first exemplary embodiment of the present disclosure.

FIGS. 3A and 3B illustrate features, actions, and effects of the vibration type motor according to the first exemplary embodiment of the present disclosure.

FIGS. 4A to 4C illustrate outer appearances of a vibration type motor according to a second exemplary embodiment of the present disclosure.

FIGS. 5A and 5B are fragmentary perspective views illustrating the vibration type motor according to the second exemplary embodiment of the present disclosure.

FIGS. 6A and 6B illustrate features, actions, and effects of the vibration type motor according to the second exemplary embodiment of the present disclosure.

FIGS. 7A to 7C illustrate a Head Mount Display (HMD) according to a third exemplary embodiment of the present disclosure.

### DESCRIPTION OF THE EMBODIMENTS

Exemplary embodiments of the present disclosure will be described below.

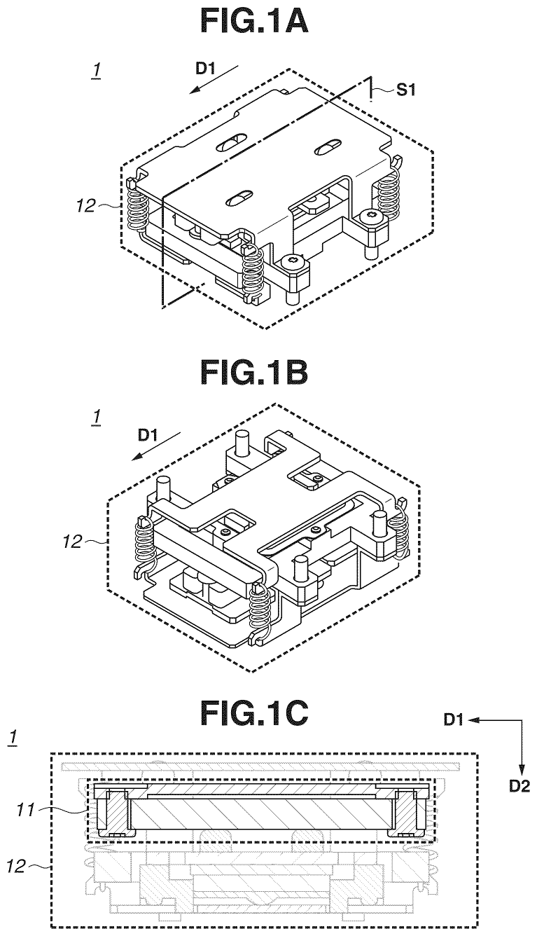

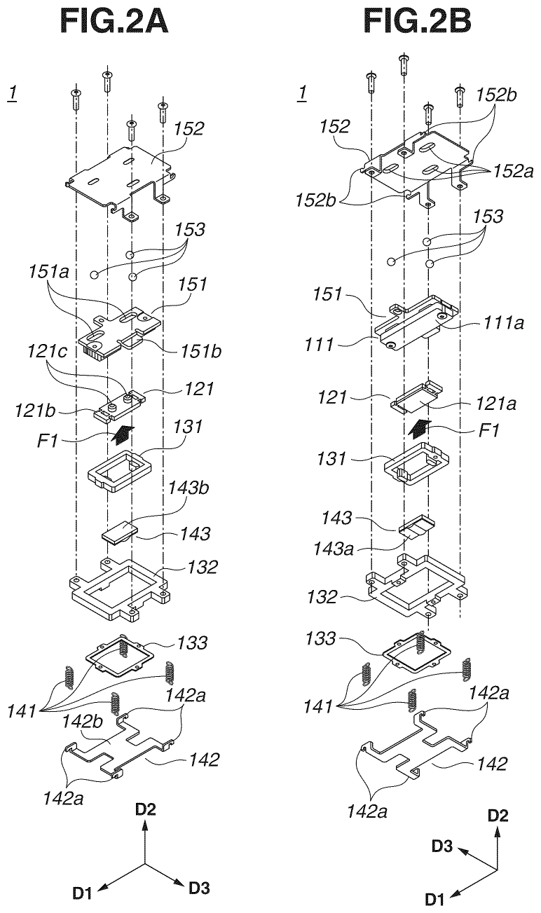

A vibration type motor 1 according to a first exemplary embodiment will be described below. FIGS. 1A and 1B illustrate outer appearances of the vibration type motor 1. FIGS. 2A and 2B are fragmentary perspective views illustrating the vibration type motor 1.

FIGS. 1A and 1B are perspective views illustrating the vibration type motor 1 viewed from one side and the other side of a direction parallel to a pressure direction D2, respectively, in which a vibrator 121 is pressed. FIG. 1C is a cross-sectional view illustrating the vibration type motor 1 taken along the cross-section S1 of FIG. 1A. The vibration type motor 1 includes a fixed unit 12 and a movable unit 11. Referring to the outer appearances in FIGS. 1A and 1B, the movable unit 11 is covered by the fixed unit 12 and is disposed inside the vibration type motor 1 as illustrated in FIG. 1C. The movable unit 11 is driven in the direction D1 illustrated in FIGS. 1A to 1C. According to the present exemplary embodiment, the relative position between the two different units changes when the vibration type motor 1 generates a driving force. One unit that serves as a positional reference is referred to as the fixed unit 12, and the other unit is referred to as the movable unit 11. Therefore, the position of the fixed unit 12 of the vibration type motor 1 may move in an apparatus mounting the vibration type motor 1.

A detailed structure of the vibration type motor 1 will be described below with reference to FIGS. 2A and 2B. FIGS. 2A and 2B are fragmentary perspective views illustrating the vibration type motor 1 viewed from different directions. FIG. 2A is a perspective view viewed from the same direction as FIG. 1A. FIG. 2A illustrates a state where the vibration type motor 1 illustrated in FIG. 1A is rotated by 180 degrees around an axis parallel to the pressure direction D2.

The vibration type motor 1 includes the vibrator 121 that vibrates and generates a driving force by voltage application, and a contact member 111 that comes into friction contact with the vibrator 121. The vibration type motor 1 further includes a vibrator holding mechanism for holding the vibrator 121, a pressure mechanism for pressing the vibrator 121 to the contact member 111 with a pressure force F1, and a guide mechanism for guiding the movable unit 11 to move relative to the fixed unit 12 in the direction D1.

The vibrator holding mechanism includes a vibrator holding frame 131, a fixed frame 132, and a connection plate 133. The pressure mechanism includes pressure springs 141, a pressure plate 142, and a buffering member 143. The guide mechanism includes a movable guide member 151, a fixed guide member 152, and rolling balls 153. The fixed unit 12 includes the vibrator 121, the vibrator holding mechanism, the pressure mechanism, and the fixed guide member 152. The movable unit 11 includes the contact member 111 and the movable guide member 151. According to the present exemplary embodiment, the movable unit 11 is driven to move in the driving direction D1, the vibrator 121 is pressed toward the contact member 111 with the pressure force F1 in the pressure direction D2, and the direction perpendicular to the driving direction D1 and the pressure direction D2 is a width direction D3.

The vibrator 121 is a structure formed of, for example, a piezoelectric element 121a and an elastic member 121b having two projections 121c stuck on the piezoelectric element 121a. The piezoelectric element 121a is, for example, a plate member made of lead zirconate titanate (PZT). The elastic member 121b is, for example, a metal plate. When a predetermined alternating-current (AC) voltage is applied to the piezoelectric element 121a, an elliptic motion occurs at the tips of the projections 121c.

The vibrator holding frame 131, for example a frame made of a resin, is directly bonded to the vibrator 121 with an adhesive to hold the vibrator 121. The fixed frame 132 and the connection plate 133 are, for example, a frame made of a resin and a thin metal plate, respectively. The connection plate 133 is provided with high rigidity in the planar direction and low rigidity in the bending direction. Therefore, by connecting the vibrator holding frame 131 and the fixed frame 132 via the connection plate 133, the vibrator 121 and the vibrator holding frame 131 are movable relative to the fixed frame 132 in the pressure direction D2, and are held while being regulated in movement in the driving direction D1. The fixed guide member 152 is, for example, a metal plate provided with guide grooves 152a, extending in the driving direction D1, and hooks 152b.

The contact member 111 is, for example, an approximately rectangular parallelepiped metallic bar that comes into friction contact with the projections 121c of the vibrator 121 on a sliding surface 111a. The movable guide member 151 is, for example, a metal plate provided with guide grooves 151a, extending in the driving direction D1, and a guide surface 151b. The contact member 111 is fastened to the movable guide member 151 by screws, to be integrated as the movable unit 11.

The pressure springs 141 are, for example, tension coil springs. The pressure plate 142 is, for example, a metal plate having hooks 142a. When one end of the pressure springs 141 is hooked onto the hooks 152b of the fixed guide member 152, and the other end of the pressuring springs 141 is hooked onto the hooks 142a of the pressure plate 142, the springs 141 are elastically deformed, and the pressure force F1 for biasing the vibrator 121 to the contact member 111 is generated. The buffering member 143 is, for example, formed of a resin plate 143a and a felt 143b stuck on the resin plate 143a. The pressure force F1 generated by the pressure springs 141 is transmitted to the vibrator 121 via the pressure plate 142 and the buffering member 143. The vibrator 121 and the vibrator holding frame 131 are held movably in the pressure direction D2. Therefore, the projections 121c of the vibrator 121 are pressed onto the sliding surface 111a of the contact member 111 while the pressure force F1 is not disturbed by the vibrator holding mechanism.

The guide grooves 152a of the fixed guide member 152 are disposed at positions facing the guide grooves 151a and the guide surface 151b of the movable guide member 151. The rolling balls 153 are disposed between these facing portions. The rolling balls 153 are pinched between the fixed guide member 152 and the movable guide member 151 by the pressure force F1 generated by the pressure springs 141. Since the pinched rolling balls 153 roll, the movable guide member 151 is held to be linearly movable relative to the fixed guide member 152 only in the driving direction D1. Thus, the movable unit 11 is held to be linearly movable relative to the fixed unit 12 only in the driving direction D1.

Generating a driving force by applying a voltage to the vibrator 121 in such a structure can drive the movable unit 11 relative to the fixed unit 12 in the driving direction D1.

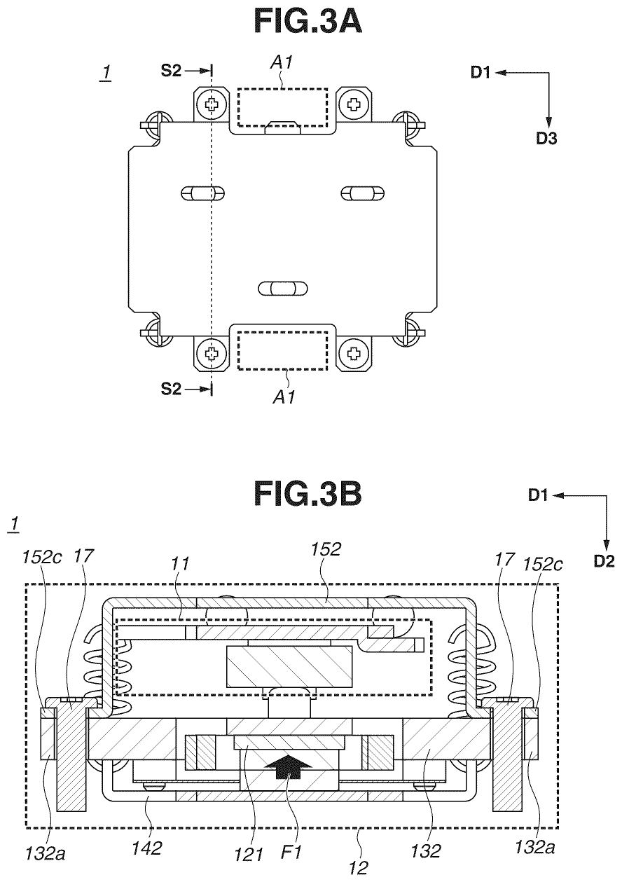

Features of the vibration type motor 1 according to the present exemplary embodiment will be described below. FIGS. 3A and 3B illustrate features, actions, and effects of the vibration type motor 1. FIG. 3A illustrates the vibration type motor 1 viewed from the fixed guide member 152 along a direction parallel to the pressure direction D2. FIG. 3B is a cross-sectional view illustrating the vibration type motor 1 taken along the cross-section S2 of FIG. 3A.

As illustrated in FIG. 3B, in the vibration type motor 1, the movable unit 11 is pinched by the vibrator 121 and the fixed guide member 152 through the pressure force F1. The fixed frame 132 of the vibrator holding mechanism has a first fixed member 132a fixed to a base member of an attachment target apparatus (hereinafter simply referred to as a base member). The fixed guide member 152 has a second fixed member 152c fixed to the base member. The first fixed member 132a and the second fixed member 152c are adjacently disposed in the pressure direction D2. The first fixed members 132a and the second fixed members 152c are fastened together to the base member by four different screws 17 as fastening members. More specifically, common screws can be inserted into the first fixed members 132a and the second fixed members 152c.

The screw 17 is inserted into the first fixed member 132a and the second fixed member 152c in a direction approximately parallel to the pressure direction D2. The first fixed member 132a and the second fixed member 152c can be said to be disposed adjacently in the insertion direction of the screw 17.

As described above, the vibrator 121 and the fixed frame 132 are relatively movable in the pressure direction D2.

Meanwhile, the fixed frame 132 is sandwiched between the fixed guide member 152 and the pressure plate 142 in the pressure direction D2. Therefore, when the fixed frame 132 moves relative to the vibrator 121 by a predetermined amount in the pressure direction D2, the fixed frame 132 comes into contact with any one member and is regulated. In this way, the relative moving amount between the first fixed member 132a disposed on the fixed frame 132 and the vibrator 121 in the pressure direction D2 is regulated to a predetermined amount or less.

Effects of the vibration type motor 1 according to the present exemplary embodiment will be described below. Generally, with a vibration type motor, it is preferable to firmly bond the vibrator holding mechanism and the guide mechanism through screw fastening or adhesion. If the two mechanisms are not firmly bonded, the vibration of the vibrator 121 may cause an abnormal sound, or a backlash may occur between the two mechanisms possibly disabling smooth drive. Generally, with a vibration type motor, it is also preferable to firmly bond the fixed unit 12 to the base member of an apparatus having driven members through screw fastening or adhesion. If the fixed unit 12 and the base member are not firmly bonded, a backlash may occur between the fixed unit 12 and the base member, possibly disabling smooth drive.

Therefore, preferably, the vibrator holding mechanism and the guide mechanism are bonded with screws, and the fixed unit 12 is bonded to the base member with screws. However, large numbers of screws and structural parts around screws in the vibration type motor are required, resulting in an increase in size of the vibration type motor.

To solve this issue, with the vibration type motor 1, the vibrator 121 is disposed in the fixed unit 12, and the first fixed member 132a of the fixed frame 132 and the second fixed member 152c of the fixed guide member 152 are adjacently disposed in the pressure direction D2 (fastening direction of the screw 17). This enables fixing the first fixed member 132a and the second fixed member 152c to the base member of an apparatus having driven members with the same screw 17. With the vibration type motor 1, the fixed frame 132 of the vibrator holding mechanism and the fixed guide member 152 of the guide mechanism are also fixed by using the screws 17 for fixing the fixed frame 132 of the fixed unit 12 and the base member. The screws for fixing the fixed frame 132 of the vibrator holding mechanism and the fixed guide member 152 of the guide mechanism are assumed to be disposed, for example, in the region A1 illustrated in FIG. 3A. However, since the vibration type motor 1 requires no screw in the region A1, the number of screws of the vibration type motor 1 can be reduced. This enables downsizing the vibration type motor 1 at least by the volume of the region A1.

With the above-described structure, in a state where the vibration type motor 1 is not fixed to the base member, the fixed frame 132 of the vibrator holding mechanism and the fixed guide member 152 of the guide mechanism are not fixed, and members may be possibly separated.

To solve this issue, the vibration type motor 1 has a structure in which the movable unit 11 is pinched by the vibrator 121 and the fixed guide member 152. With this structure, the pressure force F1 makes the fixed guide member 152 unlikely to separate from the vibrator 121 in the pressure direction D2 even in a state where the vibration type motor 1 is not fixed to the base member. As described above, the moving amount of the fixed frame 132 of the vibrator holding mechanism having the first fixed member 132a relative to the vibrator 121 in the pressure direction D2 is regulated to a predetermined amount or less. The above-described structure regulates the positions of the fixed frame 132 having the first fixed member 132a and the fixed guide member 152 having the second fixed member 152c relative to the vibrator 121 in the pressure direction D2. This enables preventing the complete separation between the first fixed member 132a and the second fixed member 152c in the pressure direction D2, thus maintaining the unitized state of the vibration type motor 1 even in a state where the vibration type motor 1 is not fixed to the base member.

As described above, the present exemplary embodiment reduces the numbers of screws and structural parts around screws in the vibration type motor 1, making it possible to restrict the increase in size of the vibration type motor 1.

As illustrated in FIGS. 2A and 2B, the vibrator holding mechanism of the vibration type motor 1 includes the vibrator holding frame 131 for holding the vibrator 121, the fixed frame 132 having the first fixed member 132a, and the connection plate 133 as a connection member for connecting the vibrator holding frame 131 and the fixed frame 132. With the vibration type motor 1, if the fixed frame 132 having the first fixed member 132a moves relative to the vibrator 121 in the pressure direction D2, the fixed frame 132 comes into contact with the regulation surface 142b of the pressure plate 142 in FIG. 2B to regulate the relative moving amount to a predetermined amount or less. Preferably, a regulation member for regulating the moving amount of the fixed frame 132 in the pressure direction D2 is disposed on a member which is unlikely to change in position relative to the vibrator 121 in the pressure direction D2. With the vibration type motor 1, examples of members unlikely to change in position relative to the vibrator 121 in the pressure direction D2 include the pressure mechanism which is stacked on the vibrator 121 in the pressure direction D2 when pressing the vibrator 121, and the vibrator holding frame 131 which holds the vibrator 121.

Therefore, preferably, the regulation member for regulating the moving amount of the fixed frame 132 in the pressure direction D2 is disposed on the pressure mechanism or the vibrator holding frame 131.

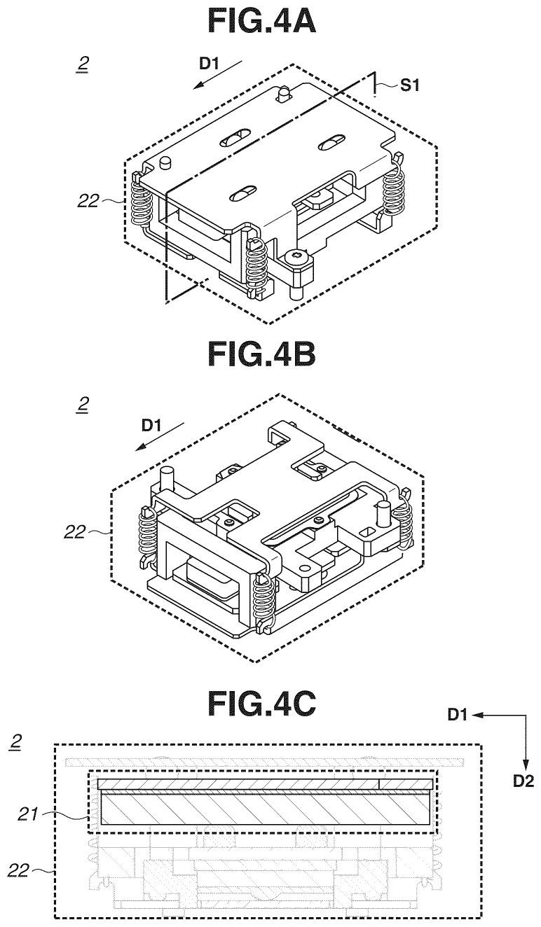

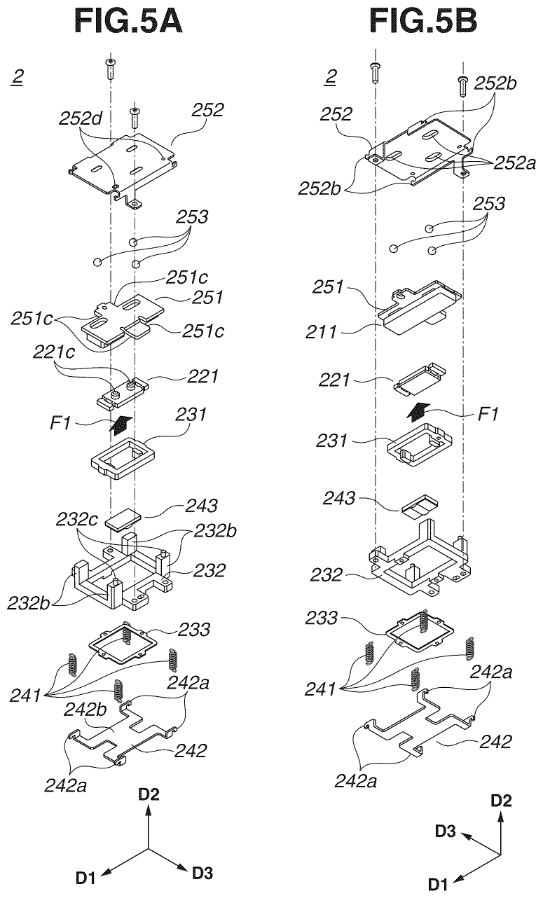

A vibration type motor 2 according to a second exemplary embodiment will be described below. FIGS. 4A and 4B illustrate outer appearances of the vibration type motor 2. FIGS. 5A and 5B are fragmentary perspective views illustrating the vibration type motor 2.

FIGS. 4A and 4B are perspective views illustrating the vibration type motor 2 viewed from one side and the other side of a direction parallel to the pressure direction D2, respectively. FIG. 4C is a cross-sectional view illustrating the vibration type motor 2 taken along the cross-section S1 of FIG. 4A. The vibration type motor 2 includes a fixed unit 22 and a movable unit 21. Referring to the outer appearances in FIGS. 4A and 4B, the movable unit 21 is covered by the fixed unit 22 and is disposed inside the vibration type motor 2 as illustrated in FIG. 4C. The movable unit 21 is driven in the direction D1 illustrated in FIGS. 4A to 4C.

A detailed structure of the vibration type motor 2 will be described below with reference to FIGS. 5A and 5B. FIGS. 5A and 5B are fragmentary perspective views illustrating the vibration type motor 2 viewed from different directions. FIG. 5A illustrates the vibration type motor 2 viewed from the same direction as FIG. 4A. FIG. 5A illustrates a state where the vibration type motor 2 illustrated in FIG. 4A is rotated by 180 degrees around an axis parallel to the pressure direction D2.

The vibration type motor 2 having a similar basic structure to the vibration type motor 1 includes a vibrator 221 and a contact member 211. The vibration type motor 2 further includes a vibrator holding mechanism, a pressure mechanism, and a guide mechanism. The vibrator holding mechanism includes a vibrator holding frame 231, a fixed frame 232, and a connection plate 233. The pressure mechanism includes pressure springs 241, a pressure plate 242, and a buffering member 243. The guide mechanism includes a movable guide member 251, a fixed guide member 252, and rolling balls 253. The fixed unit 22 includes the vibrator 221, the vibrator holding mechanism, the pressure mechanism, and the fixed guide member 252. The movable unit 21 includes the contact member 211 and the movable guide member 251.

The definitions of the driving direction D1, the pressure direction D2, and the width direction D3 are similar to those of the vibration type motor 1. Descriptions of the materials of members are similar to those of the vibration type motor 1.

With the vibrator holding mechanism, the vibrator 221 and the vibrator holding frame 231 are movable relative to the fixed frame 232 in the pressure direction D2, and are held while being regulated in movement in the driving direction D1. The contact member 211 is fixed to the movable guide member 251 by an adhesive such as a double-sided adhesion tape, to be integrated as the movable unit 21. The movable unit 21 is held to be linearly movable relative to the fixed unit 22 only in the driving direction DI by the guide mechanism.

With the vibration type motor 2, the fixed frame 232 has column members 232b, and positioning bosses 232c are disposed at the tip of the column members 232b. The movable guide member 251 is provided with drive regulation members 251c that come into contact with the column members 232b when the movable unit 21 moves by a predetermined amount in the driving direction D1. The drive regulation members 251c are disposed on both sides of the contact point between the vibrator 221 and the contact member 211 in the width direction D3, and receives the movable unit 21 when the movable unit 21 reaches the end in the driving direction D1. The fixed guide member 252 is provided with positioning holes 252d into which the positioning bosses 232c fit in the pressure direction D2. The positioning bosses 232c and the positioning holes 252d as fitting members fitting into each other regulate the relative movements of the fixed frame 232 having a first fixed member 232a and the fixed guide member 252 having a second fixed member 252c in the driving direction D1 and the width direction D3 perpendicular to the pressure direction D2.

By applying a voltage to the vibrator 221 to generate a driving force, this structure enables driving the movable unit 21 relative to the fixed unit 22 in the driving direction D1.

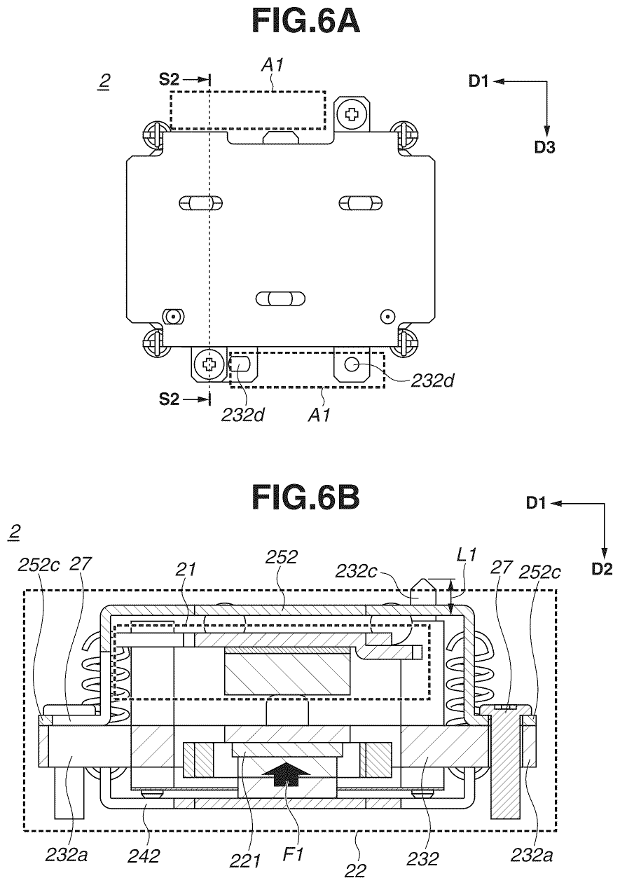

Features of the vibration type motor 2 according to the present exemplary embodiment will be described below. FIGS. 6A and 6B illustrate features, actions, and effects of the vibration type motor 2. FIG. 6A illustrates the vibration type motor 2 viewed from the fixed guide member 252 in a direction parallel to the pressure direction D2. FIG. 6B is a cross-sectional view illustrating the vibration type motor 2 taken along the cross-section S2 of FIG. 6A.

As illustrated in FIG. 6B, in the vibration type motor 2, the movable unit 21 is pinched by the vibrator 221 and the fixed guide member 252 by the pressure force F1. The fixed frame 232 of the vibrator holding mechanism includes the first fixed member 232a fixed to the base member. The fixed guide member 252 includes the second fixed member 252c fixed to the base member. The first fixed member 232a and the second fixed member 252c are adjacently disposed in the pressure direction D2 (fastening direction of the screw 27). The first fixed members 232a and the second fixed members 252c are fastened to the base member at the same time by the two screws 27 as fastening members.

The vibrator 221 and the fixed frame 232 of the vibration type motor 2 are relatively movable in the pressure direction D2. The relative moving amount between the first fixed member 232a disposed on the fixed frame 232 and the vibrator 221 is regulated to a predetermined amount or less.

The vibration type motor 2 differs from the vibration type motor 1 in the following points. The fixed frame 232 and the fixed guide member 252 of the vibration type motor 2 are provided with the positioning bosses 232c and the positioning holes 252d as fitting members for regulating the relative movements of the first fixed member 232a and the second fixed member 252c in a direction approximately perpendicular to the pressure direction D2, respectively. The direction approximately perpendicular to the pressure direction D2 includes the driving direction DI and the width direction D3. The amount of insertion of one fitting member into the other fitting member is referred to as an insertion length L1 in FIG. 6B. If the insertion length between the positioning bosses 232c and the positioning holes 252d is shorter than the insertion length L1, the relative movement in a direction perpendicular to the pressure direction D2 cannot be regulated. With the vibration type motor 2, the relative moving amount (allowable moving amount) between the vibrator 221 and the first fixed member 232a regulated by a regulation surface 242b as a regulation member in the pressure direction D2 is shorter than the insertion length between the positioning bosses 232c and the positioning holes 252d as fitting members.

Effects of the vibration type motor 2 according to the present exemplary embodiment will be described below. With the vibration type motor 2, the vibrator 221 is disposed in the fixed unit 22, and the first fixed member 232a of the fixed frame 232 and the second fixed member 252c of the fixed guide member 252 are adjacently disposed in the pressure direction D2. This enables fixing the first fixed member 232a and the second fixed member 252c to the base member of an apparatus having driven members by using the same screw 27. This structure reduces the number of screws of the vibration type motor 2, like the vibration type motor 1. Further, according to the present exemplary embodiment, the vibration type motor 2 is fixed to the base member by using two screws. The vibration type motor 2 requires a smaller number of screws than the vibration type motor 1 does to achieve downsizing.

The vibration type motor 2 is provided with no fixed member for fixing each member with a screw in the region A1 illustrated in FIG. 6A. Therefore, positioning holes 232d to be used for positioning with the base member of an apparatus having driven members can be disposed in the region A1.

The above-described structure requires that, like the vibration type motor 1, each member is not separated even in a state where the vibration type motor 2 is not fixed to the base member.

The vibration type motor 2 has a structure in which the movable unit 21 is pinched by the vibrator 221 and the fixed guide member 252. Further, the moving mount of the fixed frame 232 of the vibrator holding mechanism having the first fixed member 232a relative to the vibrator 221 in the pressure direction D2 is regulated to a predetermined amount or less. This structure enables preventing the complete separation between the fixed frame 232 having the first fixed member 232a and the fixed guide member 252 having the second fixed member 252c in the pressure direction D2. This makes it possible to maintain the unitized state of the vibration type motor 2 even if the vibration type motor 2 is not to fixed to the base member.

Further, the vibrator holding mechanism and the fixed guide member 252 of the vibration type motor 2 are provided with the positioning bosses 232c and the positioning holes 252d as fitting members for regulating the relative movement of the first fixed member 232a and the second fixed member 252c in a direction perpendicular to the pressure direction D2, respectively. With this structure, the fixed frame 232 having the first fixed member 232a and the fixed guide member 252 having the second fixed member 252c are constrained not only in the pressure direction D2 but also in a direction perpendicular to the pressure direction D2. This enables preventing the separation of members even in a state where the vibration type motor 2 is not fixed to the base member.

Further, with the vibration type motor 2, the relative moving amount (allowable moving amount) between the vibrator 221 and the first fixed member 232a in the pressure direction D2 regulated by the regulation surface 242b is shorter than the insertion length L1 between the positioning bosses 232c and the positioning holes 252d. This structure enables preventing the positioning bosses 232c and the positioning holes 252d from being separated from each other in the pressure direction D2 and preventing fitting thereof from coming loose.

This enables more securely maintaining the unitized state of the vibration type motor 2 even in a state where the vibration type motor 2 is not fixed to the base member.

Like the vibration type motor 1, the vibrator holding mechanism includes the vibrator holding frame 231 for holding the vibrator 221, the fixed frame 232 having the first fixed member 232a, and the connection plate 233 as a connection member for connecting the vibrator holding frame 231 and the fixed frame 232. With the vibration type motor 2, when the fixed frame 232 having the first fixed member 232a moves relative to the vibrator 221 in the pressure direction D2, the fixed frame 232 comes into contact with the regulation surface 242b of the pressure plate 242 in FIG. 5B to regulate the relative moving amount to a predetermined amount or less. Therefore, preferably, the regulation member for regulating the moving amount of the fixed frame 232 in the pressure direction D2 is disposed on the pressure mechanism or the vibrator holding frame 231.

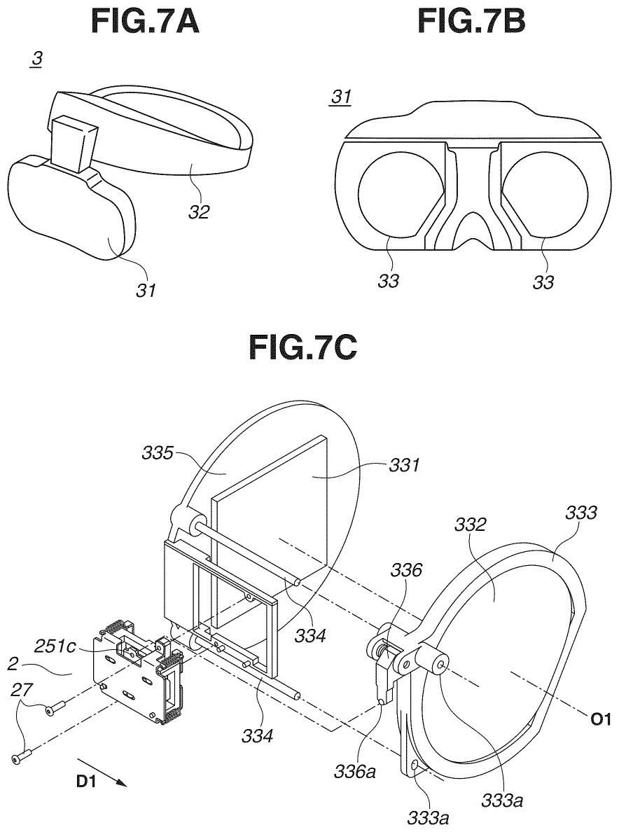

A Head Mount Display (HMD) 3 as a video display apparatus according to a third exemplary embodiment will be described below. FIGS. 7A to 7C illustrate the HMD 3. FIG. 7A is a perspective view illustrating the HMD 3. FIG. 7B illustrates an HMD main body 31 included in the HMD 3 in a state where the user mounts the HMD 3, viewed from the side facing the user. FIG. 7C is a fragmentary perspective view illustrating an internal structure of a display lens barrel 33 included in the HMD main body 31.

The HMD 3 includes the HMD main body 31 and a wearing band 32. The wearing band 32 is a circular member to be fixed to the user's head. The HMD main body 31 held by the wearing band 32 is disposed in front of the user's eyes. The wearing form of the HMD 3 is not limited to the use of the wearing band 32. For example, the form of glasses is also applicable as long as the HMD 3 can be mounted on the user's head.

As illustrated in FIG. 7B, the HMD main body 31 is provided with two display lens barrels 33 for displaying video images against the user's right and left eyes. The user can visually recognize the video images displayed on the display lens barrels 33 by looking into the display lens barrels 33.

As illustrated in FIG. 7C, each display lens barrel 33 includes a display 331, a movable lens 332, a lens holder 333, two guide bars 334, the vibration type motor 2, and a base member 335 for fixing the vibration type motor 2. With the display lens barrel 33, the optical axis of the optical system including the display 331 and the movable lens 332 is referred to as an optical axis O1.

The display 331 displays a video image. The movable lens 332 guides an appropriate video image in the optical axis direction by refracting the light beam output from the display 331. If the movable lens 332 moves in the optical axis O1 direction, the focusing state changes to change the focal distance of the video image viewed from the user.

The base member 335 holds the display 331 and the guide bars 334. The moving lens 332 is held by the lens holder 333. The lens holder 333 includes guide holes 333a into which the guide bars 334 fit. When the guide bars 334 fit into the guide holes 333a, the movable lens 332 as an optical member and the lens holder 333 for holding the movable lens 332 are held movably in a direction approximately parallel to the optical axis O1 direction. The lens holder 333 as a driven member has a driving force transmission member 336 that connects with the movable unit 21 of the vibration type motor 2 and transmits the driving force of the vibration type motor 2 to the lens holder 333. The vibration type motor 2 has a groove 251c that connects with the driving force transmission member 336. The groove 251c is disposed in the movable unit 21 of the vibration type motor 2 to bias a spherical projection 336a disposed on the driving force transmission member 336. Thus, the lens holder 333 and the movable lens 332 are connected with the movable unit 21 of the vibration type motor 2. The vibration type motor 2 is fixed to the base member 335 by the screws 27 in an orientation approximately parallel to the driving direction D1 and the optical axis O1. These screws 27 fit into the first fixed members 232a and the second fixed members 252c. The position fixing between the first fixed member 232a and the second fixed member 252c, and the position fixing between the vibration type motor 2 and the base member 335 are achieved by using the same screw.

The thus-structured HMD 3 can change the focal distance of the video image viewed by the user by driving the vibration type motor 2 to drive the movable lens 332 in the driving direction D1. The HMD 3 linearly drives the movable lens 332 by using the vibration type motor 2, achieving smoother and more silent focal distance change (diopter adjustment).

To change the focal distance of the display lens barrel 33 in the HMD 3, it is sufficient that the relative position between the movable lens 332 and the display 331 in the optical axis O1 direction is changed. Therefore, the movable lens 332 or the lens holder 333 is fixed to the base member 335, and the display 331 may be held movably in a direction approximately parallel to the optical axis O1 direction by the vibration type motor 2. The vibration type motor 1 may be used for the HMD 3.

A drive apparatus for moving a driven member by using the vibration type motor 1 or 2 is not limited to a video display apparatus such as an HMD. A lens or image sensor of a camera as a driven member may be moved by the vibration type motor 1 or 2.

In the descriptions of the above-described exemplary embodiments, the base member of an apparatus having driven members is not necessarily a member that serves as the base of the apparatus having the driven member. Members that do not move together with the driven member are included in the base member of the apparatus having the driven member.

The above-described exemplary embodiments make it possible to prevent the increase in size of a vibration type motor including a plurality of members fastened with fastening members.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2024-095444, filed Jun. 12, 2024, which is hereby incorporated by reference herein in its entirety.

What is claimed is:

1. A vibration type motor comprising:
a vibrator having projections, the vibrator being configured to vibrate by a voltage application;
a contact member configured to come into contact with the projections of the vibrator;
a holding mechanism configured to hold the vibrator;
a pressure mechanism configured to press the vibrator toward the contact member;
a fixed unit; and
a movable unit movable relative to the fixed unit by vibrating the vibrator,
wherein the holding mechanism includes a first fixed member into which a fastening member, configured to fix the vibration type motor and a base member of an apparatus having driven members, is inserted,
wherein the fixed unit includes a fixed guide member configured to guide a movement of the movable unit relative to the fixed unit, the fixed guide member including a second fixed member into which the fastening member is inserted, and
wherein the first and the second fixed members are adjacently disposed in a direction in which the fastening member is inserted into the first fixed member.

2. The vibration type motor according to claim 1,
wherein the holding mechanism comprises:
a holding frame configured to hold the vibrator;
a fixed frame including the first fixed member; and
a connection member configured to connect the holding frame and the fixed frame, and
wherein the pressure mechanism or the holding frame includes a regulation member configured to regulate a moving amount of the fixed frame relative to the vibrator in a pressure direction of the pressure mechanism.

3. The vibration type motor according to claim 2, wherein the holding mechanism and the fixed guide member include a fitting member configured to regulate a relative movement between the first fixed member and the second fixed member in a direction approximately perpendicular to the pressure direction.

4. The vibration type motor according to claim 3, wherein an allowable moving amount of the first fixed member relative to the vibrator in the pressure direction regulated by the regulation member is shorter than an insertion length of the fitting member.

5. The vibration type motor according to claim 1, wherein the fastening member is a screw.

6. The vibration type motor according to claim 1, wherein each of the first and the second fixed members is disposed at two different positions.

7. The vibration type motor according to claim 1, wherein the vibrator is included in the fixed unit, and the contact member is included in the movable unit.

8. A drive apparatus comprising:
the vibration type motor according to claim 1; and
the base member,
wherein the fastening member is inserted into the first member and the second fixed member to fix the vibration type motor and the base member.

9. A video display apparatus comprising:
the vibration type motor according to claim 1;
a display unit;
an optical member configured to guide a light beam output from the display unit in an optical axis direction; and
the base member,
wherein the driven member is the display unit or the optical member, and
wherein the fastening member is inserted into the first fixed member and the second fixed member to fix the vibration type motor and the base member.

10. The video display apparatus according to claim 9, wherein the vibration type motor changes a relative position between the display unit and the optical member in the optical axis direction.

11. The video display apparatus according to claim 9, wherein the video display apparatus is mounted on a user's head.
